(19) United States
(12) Patent Application Publication
(10) Pub. No.: US 2004/0070199 A1
(43) Pub. Date: Apr. 15, 2004

(54) Welded joint for metal pipes

(76) Inventor: Enrique Trivelli, Buenos Aires (AR)

Correspondence Address: HODGSON RUSS LLP, ONE M & T PLAZA, SUITE 2000, BUFFALO, NY, 14203-2391, US

(21) Appl. No.: 10/459,677

(22) Filed: Jun. 11, 2003

(30) Foreign Application Priority Data
Jun. 12, 2002 (AR) P 02 01 02214

(51) Int. Cl. F16L 9/14

(52) U.S. Cl. 285/55; 285/288.1

(57) ABSTRACT

A welded joint for metal pipes provided with an inner lining, which is resistant to damages caused by the fluids flowing through them. The pipes are machined in the inside at the areas next to the ends to be joined, forming an undercut at each end. An spacer ring is inserted in the hollow annular space formed by both undercuts. The outer diameter of this spacer ring is substantially equal to the diameter of the corresponding undercuts, and its axial length is substantially equal or less than the sum of the axial lengths of the undercuts of the pipes to be joined. The spacer ring is made of an outer annular layer of a high thermal conductivity metal and at least one inner annular layer of heat-insulating and heat resistant material. The outer annular layer abuts in heat conducting contact with the metal pipes within said undercuts, and the metal pipes are joined by a weld seam.

The present invention relates to a welded joint for metal pipes provided with an inner lining which is resistant to fluids to be conveyed through said pipes, but which can be affected by welding heat.

Pipelines used at present for fluid pipelines, e.g. for the petroleum industry, chemistry or the like, usually consist of pipe sections 6 to 13 meters long, with a fluid resistant inner lining. Joining of the pipes sections in order to form pipelines with the required length has always been a problem. If the inner lining is made using a material resistant to the high temperatures occurring during welding, e.g. a layer of cured epoxi paint, this protective layer consists of one or more paint layers according to each component, making up a protective layer about 250-300 microns-thick. As the protective layer thickness increases, its fragility also increases. When handling the pipes at the field, the layer can break easily, leaving the pipe metal exposed to fluids action.

If the inner lining is made of an extruded plastic material, considerably thicker, a greater resistance against mechanical damage can be obtained. However, none of these constructions allows pipe sections to be joined by welding, because the high temperatures required would destroy the inner lining, allowing the fluids to damage the steel pipes in the joint welding area.

Therefore, this kind of pipes with inner lining should be joined by means of mechanical joints, such as flanges, threaded joints, etc., causing greater cost, and increasing the risk of leaks.

The present invention is aimed at obtaining a welded joint for metal pipes, in particular steel pipes, with inner lining resistant to fluids but not to high temperatures, intended to overcome the mentioned disadvantages, i.e. avoid deterioration or destruction of the inner lining during butt welding of metal pipes, ensuring the joint sealing properties and fluid resistance.

This object is attained by means of a butt welded joint of two metal pipes provided with an inner lining of any thickness and/or composition according to their required use, but not resistant to high temperatures, wherein the inner surfaces of said pipes are radially machined in the area next to the ends to be joined, at least until exposing the metal interior surface of the pipes, forming an undercut at each end of the pipe, a spacer ring being inserted in the hollow annular space formed by both undercuts. The outer diameter of the spacer ring is substantially equal to the inner diameter of the respective undercuts, and its axial length is equal to or less than the sum of the axial lengths of the undercuts of the pipes to be joined. Said spacer ring is made of an outer annular metal layer, heat resistant and having high thermal conductivity, and at least one inner annular layer of heat insulating and heat resistant material, according to the required service thereof. The outer surface of the outer annular layer and the surfaces of said undercuts of the metal pipes are in heat conducting contact, being the metal pipes joined by means of a weld seam.

In the case that the inner annular layer presents sufficient resistance and sealing properties with respect to the fluid to be conveyed, the joint would be completed. However, since working and manufacturing tolerances often do not ensure a leak-resistant sealing contact between the inner annular layer and the pipes inner lining, or said inner annular layer does not have sufficient resistance and/or sealing properties with respect to the fluid to be conveyed, according to other embodiment of the invention, the spacer ring has a second inner layer resistant to the fluid to be conveyed, which abuts sealingly against the inner lining.

This second inner layer does not need to have heat resistance nor heat insulating properties as the first inner annular layer. The outer annular layer of the spacer ring, which will heat by contact with the hot welding material, is in heat conducting contact with the pipes metal walls, therefore forming together a heat dissipator. The small rate of welding heat which could be transmitted towards the inside of the pipes generates a decreasing temperature gradient on the first inner annular layer, so that this first inner annular layer's temperature only increases slightly during the time necessary to form the welding, but not affecting the second inner annular layer.

In another embodiment of the invention, the second inner annular layer of the spacer ring has an inner diameter which is substantially equal to the inner diameter of the undercuts, and a length which is substantially equal to the distance between the pipes lining undercuts. Accordingly, there is no narrowing of the pipe inner diameter in the welding area.

According to another embodiment of the present invention, the second annular layer has an inner diameter lesser than the inner diameter of the inner lining and a length greater than the distance between the undercuts of the inner linings, decreasing the pipe's inner diameter in the welding area, but forming sealing lips which sealingly abut against the inner lining, ensuring greater impermeability.

By the latter construction, the second inner annular layer not only covers the other two annular layers of the spacer ring, but also covers a portion of the lining inner surface. This also allows the second inner annular layer to be fastened by means of adhesive, which completely avoids fluid penetration.

For those cases where the disadvantage of narrowing of the pipe's inner diameter caused by using the above-mentioned construction are not acceptable, other embodiment of the present invention provides a welded joint in which the pipe ends to be joined are machined with a first undercut made by removing part of the length of the inner lining and full thickness of the inner lining, and forming second adjacent undercuts made by removing the length and other adjacent parts of the inner lining and part of the thickness of the inner lining; the outer layer and first inner layer of the spacer ring are inserted in the annular space between the first undercuts of the pipes ends to be joined, and the second inner annular layer is inserted in the space axially defined between the second undercuts.

This construction practically does not cause narrowing in the inner lining's pipe, ensuring at the same time a great adherence surface between the inner lining and the second inner annular layer.

In case there may be a risk that the adhesive used for adhering the inner lining pipe to the second inner annular layer cannot withstand damages caused by the different fluids to be conveyed, it has been foreseen according to the invention that the second inner annular layer has on its outer peripheral surface as well as the portions corresponding to the second undercuts, peripheral grooves to seat sealing O-rings.

Said O-rings, normally made of synthetic rubber, can ensure the sealing between the inner lining and the second inner annular layer, even though these component parts may suffer different dilatations due to pressure or temperature.

The present invention will be described in greater detail below with reference to the examples shown on the attached drawings, in which:

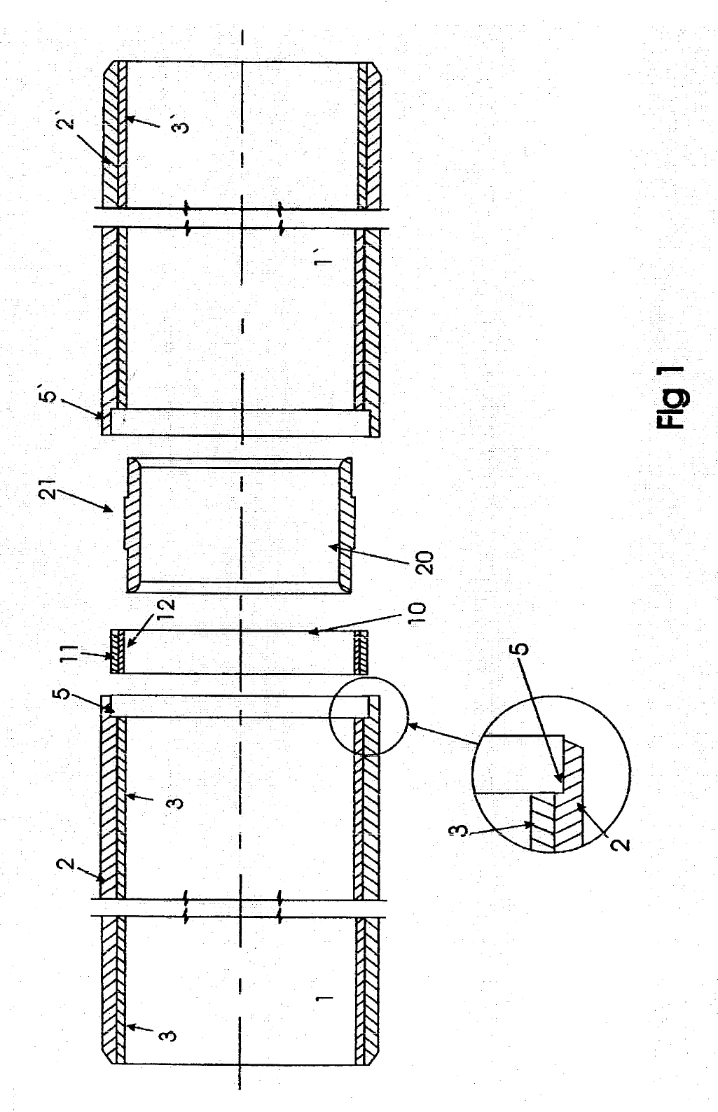

FIG. 1 is a view of an axial section through two metal pipes with inner lining, facing each other, and other component parts of the welded joint, before assembly and welding, in particular with a detail A which is a zoomed view of the pipe's bevelled front edge.

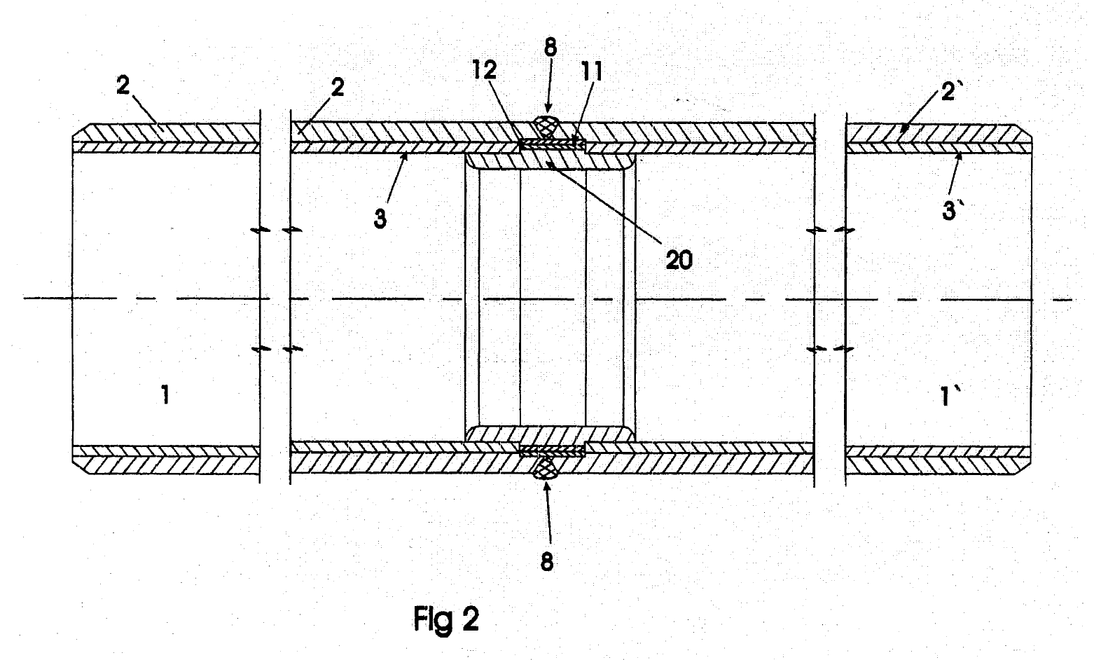

FIG. 2 is a view of the welded joint after the different component parts have been assembled and the metal pipes are welded.

FIG. 3 is a view of another embodiment of the welded joint.

As illustrated in FIGS. 1 and 2, pipes 1 and 1′ to be joined by welding consist of an outer metal pipe, particularly of steel 2, 2′, which is provided on its interior side with a lining 3, 3′, of a material capable of withstanding the action of fluids to be conveyed through said pipes.

In order to carry out the joint between pipes, an undercut 5, 5′ is machined on the inside of the pipe, at both ends, as shown in detail A of FIG. 1, removing the inner lining in a certain axial length and exposing the metal surface. Optionally, it is also possible to machine a small undercut on the inner surface of the metal pipe. At this stage, the bevel on the front edges of the metal pipe can also be cut, in a conventional manner, in order to weld the seam.

To apply the weld seam and protect the inner lining, e.g. of plastic, against the welding heat, the invention provides interposing a tubular sleeve shaped spacer ring 10, which outer diameter is substantially equal to the inner diameter of the undercut 5, 5′ machined in both inner end portions of the pipes to be joined, being its axial length approximately equal or less than the sum of the axial length of the undercuts 5, 5′ at the respective ends of the pipes 1, 1′ to be joined.

The spacer ring 10 according to the invention is made of an outer annular layer 11 made of metal with high Thermal conductivity and at least one inner annular layer 12 of heat insulating and heat resistant material, as asbestos, glass fibers or the like.

In a preferred embodiment of the present invention, the spacer ring 10 has a second inner annular layer 20, made of a material which can withstand fluids, but which is not heat resistant. This second inner annular layer 20 ensures continuity of the inner lining in the welded joint area.

To ensure fluid sealing of the second inner annular layer 20, an adhesive resistant to the fluids flowing through the pipes is applied on the contact surfaces.

Finally, a weld seam 8 is applied, e.g. by means of electric welding, on the periphery of the bevelled front edges of the metal pipes 1, 1′ to be joined.

The electric welding is carried out in a conventional manner in order to join the bevelled front edges of the metal pipes. The heat generated by welding is conducted by the outer annular metal layer 11 of the spacer ring 10 towards the inner surfaces of the undercuts 5, 5′ of the metal pipes to be joined, being the heat dissipated to the outside by the outer surfaces of pipes 1, 1′.

FIG. 3 shows another embodiment of the present invention, with no narrowing of the tube's inner diameter in the joint area.

In this case, a second inner annular layer 20, as a tubular sleeve, is located in respective second undercuts 6, 6′ which are machined on the inner lining 3, 3′ by removing only a part of the whole thickness.

The inner diameter of said second inner annular layer 20 is substantially equal to the free inner diameter of the lining, its outer diameter is less than the outer diameter of lining 3, 3′, in particular equal to the diameter of the second undercuts 6, 6′, being its axial length substantially equal to twice the sum of the axial length of the first undercut 5, 5′ and the second undercut 6, 6′.

In this case, the outer peripheral surface of the second inner annular layer 20 can lay on the insulating inner layer 12 of the spacer ring 10.

In the case the pipes shall convey different types of fluids, which eventually may damage the adhesive applied under the second inner annular layer, the invention provides peripheral grooves 24 on the outer peripheral surface of the second inner annular layer 20, in areas corresponding to the respective second undercuts 6, 6′, to seat sealing O-rings 25.

### EXAMPLE OF APPLICATION

A 1800 m-long pipelines was made using 12-m pipes. This implied the joining of 150 pipe sections, which using a conventional joint procedure by means of flanges meant a considerable additional cost. This cost can be avoided using the inventive welded joints and spacer rings. The pipelines was intended to convey a mixture of petroleum and formation water on an elevation about 100 m over the level of a pumping station.

The pipes were made of steel, having a diameter of 30 cm and wall-thickness of 6.35 mm. Before start-up, a pipe scraper was used to remove stones and boulders.

After about four months of service, the pipeline was cut in certain points in order to separate the welded joints, which were examined for deterioration. It could be verified that none of the examined joints showed damages to the inner lining, nor corrosion in the joints area. Also, the severed parts of the pipelines could easily be repaired intercalating new pipe sections and welding of the joints using the inventive technique.

1. Welded joint for metal pipes with inner lining resistant to damages by the fluids to be conveyed, wherein the pipes are machined on the inside, next to the ends to be joined, radially and for a certain axial length, at least until the inner metal surface of the pipes is exposed, forming an undercut at each end of the pipe; a spacer ring is inserted in the hollow annular space formed by both undercuts, which outer diameter is substantially equal to the respective undercut's diameter, and which axial length is substantially equal or less than the sum of the axial lengths of the undercuts; the spacer ring is made of an outer annular metal layer with high thermal conductivity and at least one inner annular layer of heat insulating and heat resistant material, the outer annular layer being in a heat-conducting contact with the metal pipes within said undercuts, and the metal pipes are joined by a welding seam.

2. Welded joint according to claim 1, wherein the spacer ring has a second inner layer, elastic and resistant to fluids, which sealingly abuts against the inner lining.

3. Welded joint according to claim 2, wherein the second inner annular layer of the spacer ring has an inner diameter which is substantially equal to the undercuts' inner diameter, and a length substantially equal to the distance between the pipes lining undercuts.

4. Welded joint according to claim 2, wherein the second inner annular layer has an inner diameter lesser than the inner diameter of the inner lining and a length greater than the distance between inner linings undercuts, decreasing the conduit inner diameter in the welding area, but forming sealing lips which sealingly abut against the inner lining.

5. Welded joint according to claim 1, wherein the pipes to be joined are machined at their ends, forming a first undercut made by removing part of the length of the inner lining and full thickness of the inner lining; and forming second adjacent undercuts made by removing other adjacent parts of the length of the inner lining and part of the thickness of the inner lining; the outer annular layer of the spacer ring is inserted in the annular space defined between the first undercuts at the facing pipes ends and the second inner annular layer is inserted in the space axially defined between the second undercuts.

6. Welded joint according to anyone of the precedent claims 1 to 5, wherein the second inner annular layer is attached by means of an adhesive within the respective undercuts.

7. Welded joint according to claim 6, wherein the second inner annular layer presents on its outer peripheral surface and on the portions corresponding with the second undercuts, peripheral grooves seating sealing O-rings.

8. Spacer ring to carry out a welded joint according to claims 1 to 7, wherein it comprises an outer annular metal layer with high thermal conductivity, and at least an inner layer of heat insulating and heat resistant material.

9. Spacer ring according to claim 8, wherein it also comprises a second not heat-resistant inner annular layer, but which is resistant to fluids contacting it.

10. Spacer ring according to claims 8 and 9, wherein the second inner annular layer is longer than the first inner annular layer, forming a hydraulic seal at its ends.

11. Use of a welded joint according to claims 1 to 7, wherein it is used for the construction of pipelines made up of pipes with inner linings resistant to chemical and/or mechanical aggressive fluids, but which lining is not heat resistant, by means of welded joints between pipes.

12. Use of a spacer ring according to claims 8 to 10, wherein it is used for the construction of pipelines made up of pipes with inner linings resistant to chemical and/or mechanical aggressive fluids, but which lining is not heat resistant, by means of welded joints between the pipes.
